(19) United States
(12) Patent Application Publication
(10) Pub. No.: US 2021/0124213 A1
(43) Pub. Date: Apr. 29, 2021

(54) QUANTUM DOT COLOR FILTER SUBSTRATE AND LIQUID CRYSTAL DISPLAY DEVICE

(71) Applicant: WUHAN CHINA STAR OPTOELECTRONICS TECHNOLOGY CO. LTD., Wuhan, Hubei (CN)

(72) Inventor: Fancheng LIU, Wuhan, Hubei (CN)

(21) Appl. No.: 16/639,756

(22) PCT Filed: Nov. 15, 2019
(86) PCT No.: PCT/CN2019/118621

§ 371 Date: Feb. 18, 2020

(30) Foreign Application Priority Data
Oct. 25, 2019 (CN) 201911022602.6

(51) Int. Cl. G02F 1/1335; G02B 5/30; G02B 5/20

(52) U.S. Cl. CPC G02F 1/133514; G02B 5/3058; G02F 2201/52; G02F 1/133528; G02F 2001/133548; G02B 5/201

(57) ABSTRACT

A quantum dot color filter substrate and a liquid crystal display device are provided. The liquid crystal display device includes the quantum dot color filter substrate, including a substrate, a band-pass filter film, a color filter layer, and an encapsulation layer; an array substrate disposed opposite to the quantum dot color filter substrate; a liquid crystal layer disposed between the quantum dot color filter substrate and the array substrate; and a backlight module disposed below the array substrate.

### FIELD OF INVENTION

The present invention relates to the field of display technology, and in particular, to a quantum dot color filter substrate and a liquid crystal display device.

### BACKGROUND OF INVENTION

Quantum dots (QDs) are nanoparticles composed of group II-VI or III-V elements, which emit fluorescence when excited. An emission spectrum can be controlled by changing sizes of the quantum dots, and their fluorescence intensity and stability are very good.

At present, there is a quantum dot color filter liquid crystal display device with an in-cell polarizer design. Its configuration of quantum dot color filter is different from traditional quantum dot color filter liquid crystal display device. The design encapsulates the quantum dot color resist on an upper surface of the color filter substrate, so that a metal wire grid polarizer can be placed on a lower surface of the color filter substrate. The metal wire grid is a nano-scale structure, and the metal wire grid is arranged on the lower surface of the color filter substrate. Since its flatness is improved, performance of the metal wire grid polarizer can be greatly improved.

### Technical Problem

The quantum dot color filter technology uses a blue light-emitting diode (LED) as a backlight source to excite a color-resist composed of quantum dots to emit light. However, as shown in FIG. 1, after red sub-pixel 101 and green sub-pixel 102 are excited by blue light 10 emitted from a backlight module 98, a generated light 11 will be depolarized, and the light 11 will pass through an in-cell polarizer 104 to enter a panel again, and cross-talk with the blue light 10, which affects display quality and reduces luminous efficacy of the quantum dot color filter.

### SUMMARY OF INVENTION

An object of the present invention is to provide a quantum dot color filter substrate and a liquid crystal display device to solve a problem that the light from the backlight source return to the inside of the panel after passing through the color filter layer, which causes the crosstalk with the color of the backlight source, such that the light-emitting quality and efficiency of the display device can be improved.

To achieve the above object, the present invention provides a quantum dot color filter substrate, including a substrate; a color filter layer disposed on the substrate including a plurality of sub-pixels arranged in an array, each sub-pixel separated by black matrix, and the sub-pixels including a red sub-pixel, a green sub-pixel, and a blue sub-pixel; a band-pass filter film disposed under the color filter layer; and an encapsulation layer disposed on the color filter layer.

Preferably, the band-pass filter film allows more than 98% of light in a wavelength range of 400 to 500 nm to pass and reflects more than 95% of light not in the wavelength range of 400 to 500 nm.

Preferably, a metal wire grid polarizer is further disposed below the substrate, and the metal wire grid polarizer is composed of a silicon oxide layer, an aluminum metal layer, and a silicon nitride layer.

Preferably, the band-pass filter film is disposed between the substrate and the metal wire grid polarizer.

Preferably, the band-pass filter film is composed of silicon oxide or indium tin oxide.

The invention further provides another quantum dot color filter substrate, including: a substrate; a color filter layer disposed on the substrate including a plurality of sub-pixels arranged in an array, each sub-pixel separated by black matrix, and the sub-pixels including a red sub-pixel, a green sub-pixel, and a blue sub-pixel; a band-pass filter film disposed on an upper surface of the substrate and a side surface of the black matrix; and an encapsulation layer disposed on the color filter layer.

Preferably, the band-pass filter film allows more than 98% of light in a wavelength range of 400 to 500 nm to pass and reflects more than 95% of light not in the wavelength range of 400 to 500 nm.

Preferably, a metal wire grid polarizer is further disposed below the substrate, and the metal wire grid polarizer is composed of a silicon oxide layer, an aluminum metal layer, and a silicon nitride layer.

Preferably, the band-pass filter film is composed of silicon oxide or indium tin oxide.

The present invention further provides a liquid crystal display device, including: a quantum dot color filter substrate including a substrate, a band-pass filter film, a color filter layer, disposed on the substrate, and an encapsulation layer disposed on the color filter layer; an array substrate disposed opposite to the quantum dot color filter substrate; a liquid crystal layer disposed between the quantum dot color filter substrate and the array substrate; and a backlight module disposed below the array substrate.

Preferably, the band-pass filter film is disposed between the color filter layer and the liquid crystal layer. It can block most of the red and green light under the premise that the pass-through of blue light of the backlight source is not affected to prevent the red or green light from entering the panel again and crosstalk with the blue light of the backlight source.

Preferably, further including a metal wire grid polarizer disposed below the quantum dot color filter substrate, and the metal wire grid polarizer is composed of a silicon oxide layer, an aluminum metal layer, and a silicon nitride layer.

Preferably, further including a polarizer between the array substrate and the backlight module.

Preferably, the band-pass filter film is composed of silicon oxide or indium tin oxide.

### Beneficial Effect

The present invention provides a quantum dot color filter substrate and a liquid crystal display device. By setting a band-pass filter film, most of red light and green light can be intercepted without affecting pass-through of blue light from a backlight source, which can prevent red or green light from entering a panel again to crosstalk with the blue light from the backlight source, thereby improving display effect.

### DESCRIPTION OF DRAWINGS

In order to more clearly illustrate the technical solutions in the embodiments of the present invention, the following figures described in the embodiments will be briefly introduced. It is obvious that the drawings described below are merely some embodiments of the present invention, and other drawings can also be obtained by a person of ordinary skills in the field based on these drawings without making any creative efforts.

FIG. 1 is a schematic sectional view of a conventional quantum dot color filter liquid crystal display device.

FIG. 2 is a schematic sectional view of a quantum dot color filter substrate according to a first embodiment of the present invention.

FIG. 3 is a schematic sectional view of a quantum dot color filter substrate according to a second embodiment of the present invention.

FIG. 4 is a schematic cross-sectional view of a quantum dot color filter substrate according to a third embodiment of the present invention.

FIG. 5 is a schematic cross-sectional view of a quantum dot color filter liquid crystal display device according to an embodiment of the present invention.

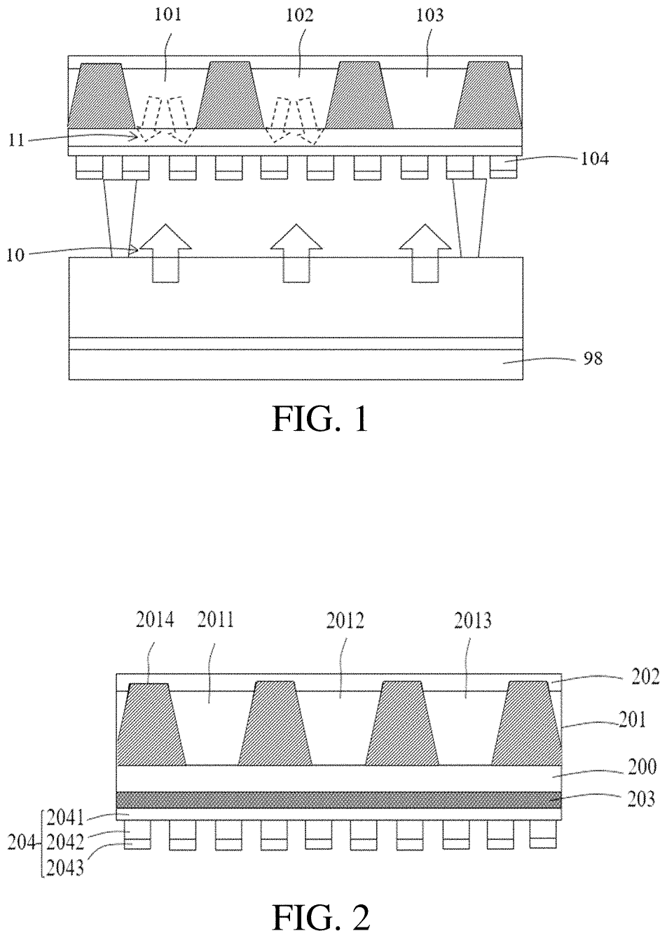

### DETAILED DESCRIPTION OF PREFERRED EMBODIMENTS

The technical solutions in the embodiments of the present invention will be clearly and completely described with reference to the accompanying drawings in the embodiments of the present invention.

Obviously, the described embodiments are only a part of the embodiments of the present invention, but not all the embodiments. Based on the embodiments of the present invention, all other embodiments obtained by those skilled in the art without creative effort fall into the protection scope of the present application. The following embodiments are described with reference to the drawings to illustrate specific embodiments of the present invention. The directional terms mentioned in the present invention, such as “above”, “below”, “front”, “back”, “left”, “right”, “in”, “out”, “side”, etc., are only directions referring to the attached drawings. Therefore, the directional terms used are for explaining and understanding the present invention, but not for limiting the present invention.

FIG. 2 is a schematic cross-sectional view of a quantum dot color filter substrate according to a first embodiment of the present invention, including:

a glass substrate 200; a band-pass filter film 203 disposed under the glass substrate 200, wherein the band-pass filter film 203 can be coated by a magnetron sputtering process, and a film material can be silicon oxide or indium tin oxide, etc.; a metal wire grid polarizer 204 disposed under the band-pass filter film 203, wherein the metal wire grid polarizer 204 is composed of a silicon oxide layer 2041, an aluminum metal layer 2042, and a silicon nitride layer 2043; a color filter layer 201 disposed on the substrate 200 including a plurality of sub-pixels arranged in an array, wherein each sub-pixel is separated by a black matrix 2014, and the sub-pixels include a red sub-pixel 2011 composed of red quantum dot material, a green sub-pixel 2012 composed of green quantum dot material, and a blue sub-pixel 2013 composed of blue quantum dot material; and an encapsulation layer 202 disposed on the color filter layer 201.

The band-pass filter film 203 has a transmittance of greater than 98% for blue light and a reflectance of more than 95% for red light and green light.

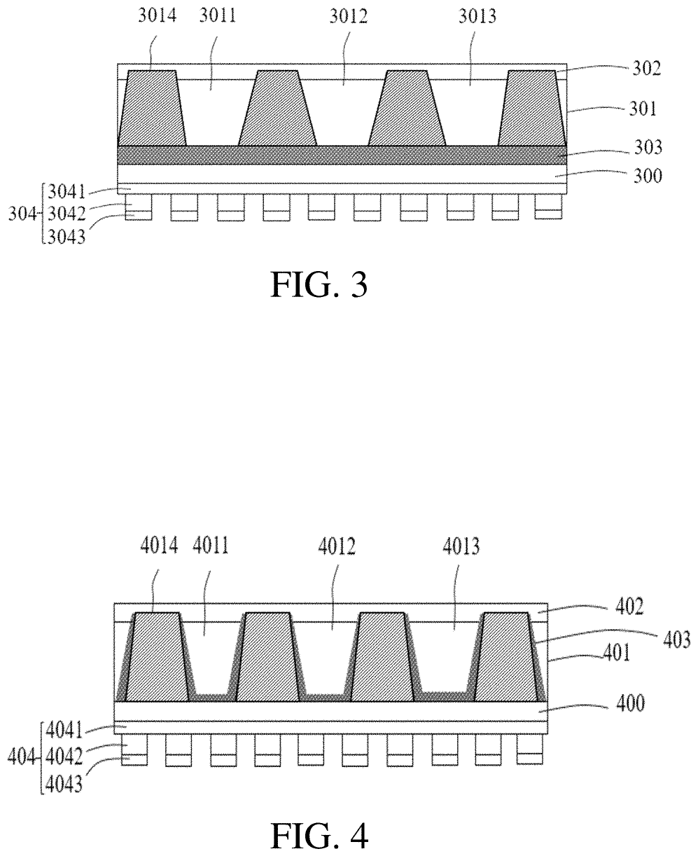

FIG. 3 is a schematic cross-sectional view of a quantum dot color filter substrate according to a second embodiment of the present invention, including:

a glass substrate 300; a band-pass filter film 303 disposed above the glass substrate 300, wherein the band-pass filter film 303 can be coated by a magnetron sputtering process, and a film material can be silicon oxide or indium tin oxide, etc.; a color filter layer 301 disposed on the band-pass filter film 303 including a plurality of sub-pixels arranged in an array, wherein each sub-pixel is separated by a black matrix 2014, and the sub-pixels include a red sub-pixel 3011 composed of red quantum dot material, a green sub-pixel 3012 composed of green quantum dot material, and a blue sub-pixel 3013 composed of blue quantum dot material; a metal wire grid polarizer 304 disposed under the glass substrate 300, wherein the metal wire grid polarizer 304 is composed of a silicon oxide layer 3041, an aluminum metal layer 3042, and a silicon nitride layer 3043; and an encapsulation layer 302 disposed on the color filter layer 301.

The band-pass filter film 303 has a transmittance of greater than 98% for blue light and a reflectance of more than 95% for red light and green light.

FIG. 4 is a schematic cross-sectional view of a quantum dot color filter substrate according to a third embodiment of the present invention, including:

a glass substrate 400; a color filter layer 401 disposed on the glass substrate 400 including a plurality of sub-pixels arranged in an array, wherein each sub-pixel is separated by a black matrix 4014, and the sub-pixels include a red sub-pixel 4011 composed of red quantum dot material, a green sub-pixel 4012 composed of green quantum dot material, and a blue sub-pixel 4013 composed of blue quantum dot material; a band-pass filter film 403 disposed on an upper surface of the glass substrate 400 and a side surface of the black matrix 4014, wherein the band-pass filter film 403 can be coated by a magnetron sputtering process, and a film material can be silicon oxide or indium tin oxide, etc.; a metal wire grid polarizer 404 disposed under the glass substrate 400, wherein the metal wire grid polarizer 404 is composed of a silicon oxide layer 4041, an aluminum metal layer 4042, and a silicon nitride layer 4043; and an encapsulation layer 402 disposed on the color filter layer 401.

The band-pass filter film 403 has a transmittance of greater than 98% for blue light and a reflectance of more than 95% for red light and green light.

An advantage of the embodiment over the first embodiment and the second embodiment is that it can further prevent light generated after exciting red, green, and blue quantum dots from propagating to left and right and being absorbed by the black matrix, thereby improving luminous efficiency.

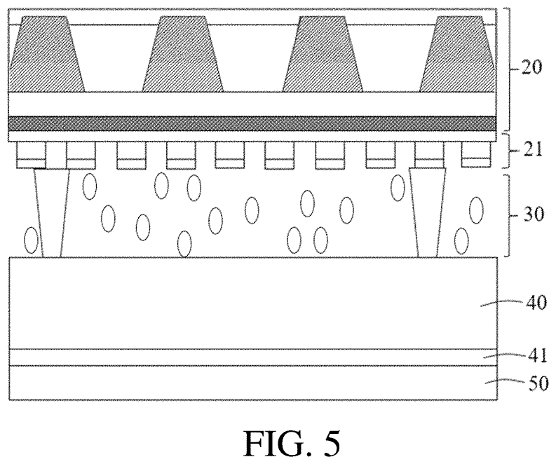

FIG. 5 is a schematic cross-sectional view of a quantum dot color filter liquid crystal display device according to an embodiment of the present invention, including:

a quantum dot color filter substrate 20; an array substrate 40 disposed opposite to the quantum dot color filter substrate 20; a liquid crystal layer 30 disposed between the quantum dot color filter substrate 20 and the array substrate 40; a metal wire grid polarizer 21 disposed under the quantum dot color filter substrate 20; and a polarizer 41 and a backlight module 50 disposed under the array substrate 40, wherein the backlight module 50 has a blue backlight source.

The quantum dot color filter substrate 20 includes the band-pass filter film according to the first embodiment to the third embodiment. Its transmittance to blue light is greater than 98%, and its reflectance to red and green light is greater than 95%. It allows more than 98% of blue light to pass and reflect more than 95% of red and green light scattered toward the liquid crystal layer 30 to a window direction of the display device, preventing crosstalk between red, green, and blue light. Therefore, display quality is enhanced, and luminous efficiency of the quantum dot color filter liquid crystal display device is improved.

The present invention has been disclosed as above with the preferred embodiments, the above embodiments are not intended to limit the application. Those of ordinary skill in the art can make various changes and modifications without departing from the spirit and scope of the application. Therefore, the protection scope of the application is subject to the scope defined by the claims.

1. A quantum dot color film substrate, comprising:
a substrate;
a color filter layer disposed on the substrate comprising a plurality of sub-pixels arranged in an array, each sub-pixel separated by black matrix, and the sub-pixels comprising a red sub-pixel, a green sub-pixel, and a blue sub-pixel;
a band-pass filter film disposed under the color filter layer; and
an encapsulation layer disposed on the color filter layer.

2. The quantum dot color film substrate according to claim 1, wherein the band-pass filter allows more than 98% of light in a wavelength range of 400 to 500 nm to pass and reflects more than 95% of light not in the wavelength range of 400 to 500 nm.

3. The quantum dot color film substrate according to claim 1, wherein a metal wire grid polarizer is further disposed below the substrate, and the metal wire grid polarizer is composed of a silicon oxide layer, an aluminum metal layer, and a silicon nitride layer.

4. The quantum dot color film substrate according to claim 3, wherein the band-pass filter is disposed between the substrate and the metal wire grid polarizer.

5. The quantum dot color film substrate according to claim 1, wherein the band-pass filter is composed of silicon oxide or indium tin oxide.

6. A quantum dot color film substrate, comprising:
a substrate;
a color filter layer disposed on the substrate comprising a plurality of sub-pixels arranged in an array, each sub-pixel separated by black matrix, and the sub-pixels comprising a red sub-pixel, a green sub-pixel, and a blue sub-pixel;
a band-pass filter film disposed on an upper surface of the substrate and a side surface of the black matrix; and
an encapsulation layer disposed on the color filter layer.

7. The quantum dot color film substrate according to claim 6, wherein the band-pass filter allows more than 98% of light in a wavelength range of 400 to 500 nm to pass and reflects more than 95% of light not in the wavelength range of 400 to 500 nm

8. The quantum dot color film substrate according to claim 6, wherein a metal wire grid polarizer is further disposed below the substrate, and the metal wire grid polarizer is composed of a silicon oxide layer, an aluminum metal layer, and a silicon nitride layer.

9. The quantum dot color film substrate according to claim 6, wherein the band-pass filter is composed of silicon oxide or indium tin oxide.

10. A liquid crystal display device, comprising:
a quantum dot color film substrate comprising a substrate, a band-pass filter film, a color filter layer, disposed on the substrate, and an encapsulation layer disposed on the color filter layer;
an array substrate disposed opposite to the quantum dot color film substrate;
a liquid crystal layer disposed between the quantum dot color film substrate and the array substrate; and
a backlight module disposed below the array substrate.

11. The liquid crystal display device according to claim 10, wherein the band-pass filter film is disposed between the color filter layer and the liquid crystal layer.

12. The liquid crystal display device according to claim 10, wherein further comprising a metal wire grid polarizer disposed below the quantum dot color film substrate, and the metal wire grid polarizer is composed of a silicon oxide layer, an aluminum metal layer, and a silicon nitride layer.

13. The liquid crystal display device according to claim 10, wherein further comprising a polarizer between the array substrate and the backlight module.

14. The liquid crystal display device according to claim 10, wherein the band-pass filter is composed of silicon oxide or indium tin oxide.
